(19) United States
(12) Patent Application Publication
(10) Pub. No.: US 2002/0073045 A1
(43) Pub. Date: Jun. 13, 2002

(54) Off-line generation of limited-use credit card numbers

(76) Inventors: Aviel D. Rubin, West Caldwell, NJ (US); Rebecca N. Wright, New York, NY (US)

Correspondence Address: AT&T CORP., P.O. BOX 4110, MIDDLETOWN, NJ, 07748, US

(21) Appl. No.: 09/682,830

(22) Filed: Oct. 23, 2001

Related U.S. Application Data
(60) Provisional application No. 60/242,556, filed on Oct. 23, 2000.

(51) Int. Cl. G06F 17/60

(52) U.S. Cl. 705/65

(57) ABSTRACT

The present invention discloses a protocol that reduces the risk of misuse of a user's card number while avoiding having to securely contact and authenticate with a card issuer before each transaction in an “online” manner.

### CROSS REFERENCE TO RELATED APPLICATIONS

This application claims priority to U.S. Provisional Application “Off-Line Generation of Limited-Use Credit Card Numbers,” Serial No. 60/242,556, filed on Oct. 23, 2000, the contents of which are incorporated by reference herein.

### BACKGROUND OF INVENTION

The invention relates to systems and methods for facilitating transactions using a credit card number.

The proliferation of ecommerce on the Internet has not resulted in a wide diversity of online payment mechanisms. While novel schemes such as Paypal (see “http://www.paypal.com”) have gained in popularity, most business to customer transactions still utilize standard credit card numbers over a Secure Socket Layer (SSL) connection. Multiple use credit cards result in increased risk for the credit card companies, which generally try to insulate their customers from risk by shouldering losses above a nominal sum. Moreover, there are several ways in which SSL can break down in the context of a credit card transaction. While SSL provides for mutual authentication, virtually all consumer oriented web merchants only implement server authentication. Despite the authentication properties of SSL, there is no guarantee that the user is not being fooled by a malicious merchant. Most users do not actually verify the certificates on a secure site; regardless, it is relatively easy for just about anyone to obtain a certificate given the large number of root signing authority public keys available.

The Secure Electronic Transactions (SET) protocol (see “http://www.setco.org”) was designed to protect credit card numbers from malicious parties, and even from malicious merchants. Unfortunately, SET has been seen as requiring too much overhead and the buyin of too many different parties. Realizing the problem, the credit card companies have started introducing solutions that can be layered over the existing infrastructure. For example, American Express has begun to offer onetime use credit cards, and Visa has begun to offer limited value gift credit cards. These solutions require users to have a secure interaction with the credit card company, in which a new credit card number is obtained that is linked to an existing account. U.S. Pat. No. 5,883,810, to Franklin et al., discloses a variation on this idea wherein users request additional “transaction” numbers from the credit card issuer for each new electronic transaction. The credit card issuer generates a new transaction number for the user and associates the transaction number with a real customer account number in a database record, which is checked when authorization for a particular merchant transaction is sought. Unfortunately, this scheme, as in the case of a user obtaining multiple conventional credit card numbers from an issuer, requires the user to directly contact the credit-card issuer before each transaction in order to obtain a new transaction number. Not only does this require some authenticated interaction with the credit card issuer before the transaction, the interaction must be secure from eavesdroppers.

### SUMMARY OF INVENTION

It is an object of the invention to reduce the risk of misuse of a user's card number while avoiding having to securely contact and authenticate with a card issuer before each transaction in an “online” manner. The present invention is directed to a protocol for generating tokens that may be used in lieu of a conventional account number and reflect transaction restrictions that must be satisfied for the transaction to be approved. The account number is assumed to be a shared secret between the card issuer and the card holder. The tokens, in accordance with an embodiment of the invention, have a length and format identical to the account number, thereby allowing easy layering of the protocol on existing commerce infrastructures. In accordance with an aspect of the invention, an account number such as a credit card number or a calling card number is converted into a symmetric cryptographic key, for example by using a cryptographic hash function. The transaction restrictions are encoded into information that is encrypted using the symmetric cryptographic key to obtain a token which may be utilized in the transaction and verified by a card issuer using the account number. In one embodiment of the invention, the tokens are generated by a program executing on a computing device. In accordance with another aspect of the invention, a card issuer receives the token and information identifying the account from a merchant requesting authorization for a transaction. The card issuer decrypts the token using a symmetric cryptographic key converted from the account number associated with the account with the card issuer. The card issuer can then verify information retrieved from the token and approve the transaction if the transaction satisfies any restrictions retrieved from the token. Thus, the tokens have functionality limited by the card holder and can be generated in an “off-line” manner without requiring any interaction with the card issuer.

These and other advantages of the invention will be apparent to those of ordinary skill in the art by reference to the following detailed description and the accompanying drawings.

### BRIEF DESCRIPTION OF DRAWINGS

FIG. 1 is an abstract diagram of a credit card transaction, illustrating a preferred aspect of the invention.

FIG. 2 is a screenshot of an illustrative user interface for a token-generation application running on a computing device.

FIG. 3 is an example of a restriction expressed as plaintext.

FIG. 4 is a flowchart of processing performed by a token-generation application running on a computing device, in accordance with a preferred embodiment of the invention.

FIG. 5 is a flowchart of processing performed by an authorization server operated by a card issuer, in accordance with a preferred embodiment of the invention.

### DETAILED DESCRIPTION

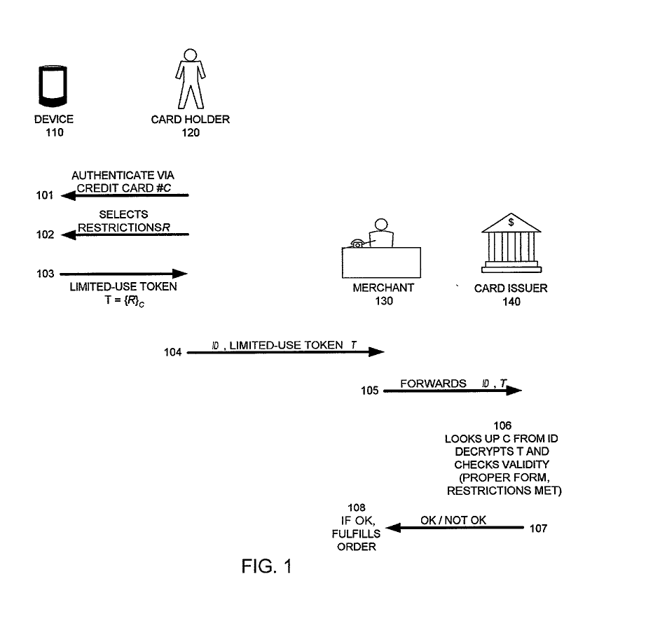

FIG. 1 is an abstract diagram of a credit card transaction, illustrating a preferred aspect of the invention. The entity with whom individuals have credit card accounts is referred to herein as a “card issuer” 140. The person with the credit card account is referred to as a “card holder” 120, and the card holder's credit card number, e.g. typically a 16 digit number such as “1234 5678 9012 3456”, is referred to herein as the “account number” of the card holder. The card holder 120—or another person with a relationship with the card holder such as the card holder's child or a gift recipient—desires to conduct a transaction with merchant 130. For simplicity, other entities that may be involved in the transaction processing, such as a merchant acquirer, are not separated out. Nevertheless, the transaction protocol is not limited to any particular architecture or structure for processing credit card authorizations and may be readily extended by one of ordinary skill in the art to situations where a merchant 130 does not talk directly to the card issuer 140.

The card holder 120 is assumed to have access to a computing device 110 that, in a preferred embodiment, can reliably hold secrets. For example and without limitation, the device can be a personal computer, a personal data assistant (PDA), such as a Palm Pilot or Windows CE device, or some other auxiliary computing device. It is preferable that the card holder 120 be capable of controlling access to the data on the device by physical or cryptographic means. The device 110 can be equipped with a smart card reader or other tamper-resistant hardware, although such means for ensuring the integrity of data stored on the device is not required for the present invention.

The computing device 110 is used to generate what the inventors refer to as a “token.” The token is preferably a credit-card like number that can be used in the place of a real credit card. The token is preferably tied to the same account of the card holder, but, unlike a typical multiple use credit card number, can have restrictions placed on its use. There are many different kinds of limitations that can be advantageously placed on the token: for example and without limitation, the number of uses of the token can be limited, its validity period, the set of recipients, the amount of money, and even the category of product for which it can be used. The restrictions can be used to protect the card holder and the card issuer in case the token is compromised. For example, a token can be specified such that it is only good for $100 worth of books from a particular book seller. Even if the token is lost or stolen, e.g. when the book seller's website is compromised as has happened in several recent high-profile cases, the tokens are rendered almost useless to a malicious hacker (or to the book seller itself if the merchant turns out to be malicious). The particular restrictions placed on the token can be chosen to help prevent the loss or theft from exposure as is possible from e-commerce. Tokens, however, can be used for features other than simply limiting risk. For example and without limitation, a token could be used to enforce a personal budget. A user could define an account number that has a particular monetary limit that can only be utilized in restaurants, and thus enforce a limit on how much they spend when eating “out”. Special restrictions can be placed on a token given to a child who goes off to college. There are a variety of creative gift possibilities with restricted tokens.

The protocol shown in FIG. 1 can be roughly divided into four parts. First, the card holder 120 chooses restrictions, if any, using an advantageous user interface on the device 110. Second, the device invokes a transformation (an encryption) from the restrictions and the account number to the token. Third, the token is communicated along with identifying information via a merchant 130 to the credit card issuer 140. Finally, the last part of the protocol is the verification of the token by the credit card issuer 140. Each step is described in further detail below.

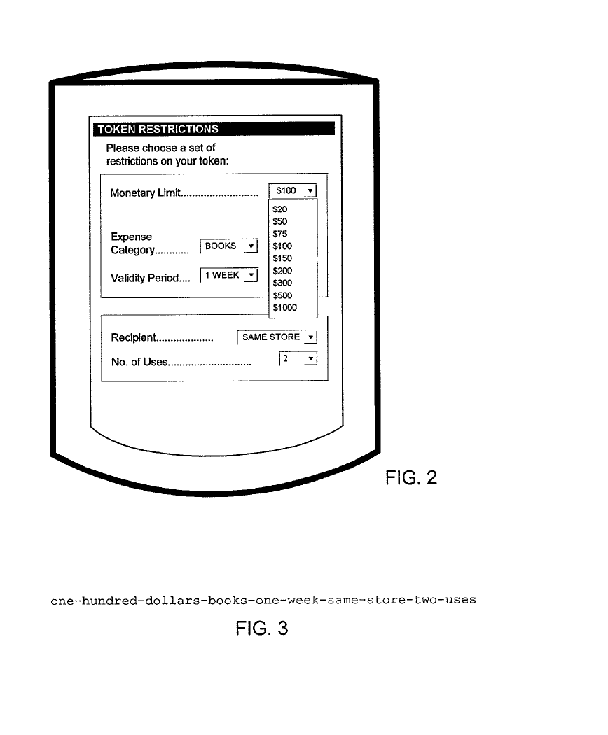

With reference to FIG. 1, the card holder 120 at step 101 interacts with a token-generation application on the device 110 locally, preferably first by authenticating to the application, e.g. by entering the account number C. Using the application, the card holder 120 selects a set, R, of restrictions to specify the type of limited usage desired at step 102. The set R is preferably chosen from a predefined finite set of restrictions represented by an advantageous user interface, e.g. pull-down menus or some other graphical interface independent of the particular device. The user interface is crucial in any system that involves many users, especially if the level of experience with computing devices varies widely. The present invention lends itself nicely to an intuitive interface, an illustrative example of which is shown in FIG. 2. The card holder's device displays a table of possible restrictions, the list of choices presented as pull-down menus. The possible restrictions are standardized around useful values: for example, the monetary restrictions can be $20, $50, $75, $100, $150, $200, $300, $500, $1000, $5000; the categories of expense can be food, books, travel, entertainment, luxury, clothing, electronics, etc.; the validity periods can be one hour, four hours, twelve hours, one day, three days, a week, a month, etc. For each type of restriction, all of the possible values are enumerated when the card holder selects the particular pull-down menu in FIG. 2. As shown in FIG. 2, the card holder has selected a monetary limit of $100 with a validity period of one week where the expense category is limited to “books” and where the token can only be utilized two times in the same store before expiring. It is also advantageous for the user interface to tailor the restriction choices based on those restrictions already chosen, i.e. certain choices early on will restrict the set of choices for other restrictions. For example, if the user selects the number of uses of the token to be one, the system may not allow for any transaction over $500. The card issuer can advantageously define the set of possible restrictions based on the particular transactions anticipated by its card holders.

The values chosen for the restrictions can be encoded into a value, R, that is utilized to generate the token. The values, for example, can be laid out in a table where the plaintext of the token consists of an index into the table. For readability, it is preferable that the plaintext tokens be represented as an enumeration of the various restrictions. This is analogous to the way cryptographic algorithms and parameters are listed in SSL ciphersuites. For example, the plaintext shown in FIG. 3 corresponds to the restrictions chosen in FIG. 2. It is also preferable to add something to the restrictions plaintext to make them unique, such as random padding, time of generation, or a sequence number. The actual padding needs to be chosen carefully, as such a transformation can be subject to various kinds of partiallyknown or guessable plaintext attacks. Without the unique information, however, different instances of the same restrictions with the same account number may not be distinguishable.

In accordance with a preferred embodiment of the invention, at step 103 in FIG. 1, the account number is converted into a symmetric cryptographic key which is utilized to encrypt the encoded restrictions R, thereby resulting in the token T. The protocol takes advantage of the fact that the card holder and the card issuer share a secret, namely the account number. The protocol leverages off of this shared secret to convey information from the card holder to the credit card issuer in a secure manner. The shared secret is converted to a symmetric key using standard techniques. For example, a cryptographic hash function, such as MD5, can be utilized where the output length is the same as the key length for the cipher. See, e.g., R. Rivest, “The MD5 Message-Digest Algorithm,” IETF Network Working Group, RFC 1321 (April 1992), which is incorporated by reference herein. The card holder's device 110 then uses the key derived from the credit card number to encrypt R and produce a token, T, which has the same form as a credit card number. Any suitable cryptographic algorithm can be utilized for the encryption. See, e.g., “Advanced Encryption Standard (AES)” National Institute of Standards and Technology, http://csrc.nist.gov/encryption/aes/. Assuming that a strong cipher is utilized, such as AES, breaking the cryptographic key amounts to discovering the credit card number. If someone knows the credit card number, then they have already compromised the system. So, as long as one can trust the cipher, the protocol should not introduce any additional exposure of the credit card number.

Given the standard account number length, tokens will typically be 16 digits long, so there are almost 16¹⁰ possible combinations of restrictions that can exist in a token. The reason it is almost that number and not exactly is that the symmetric cipher may require that the last block be padded, and, as alluded to above, it may also be advantageous to add a value for uniqueness. Thus, the number of restrictions may be slightly less than that. In fact, the first four digits of a conventional credit card number are typically used to represent a bank code, and the last digit is usually a checksum. If merchants rely on these numbers, then it is only possible to use 11 decimal digits to represent the restrictions. Still, it seems that 11¹⁰ is more than enough combinations of restrictions for most interesting applications.

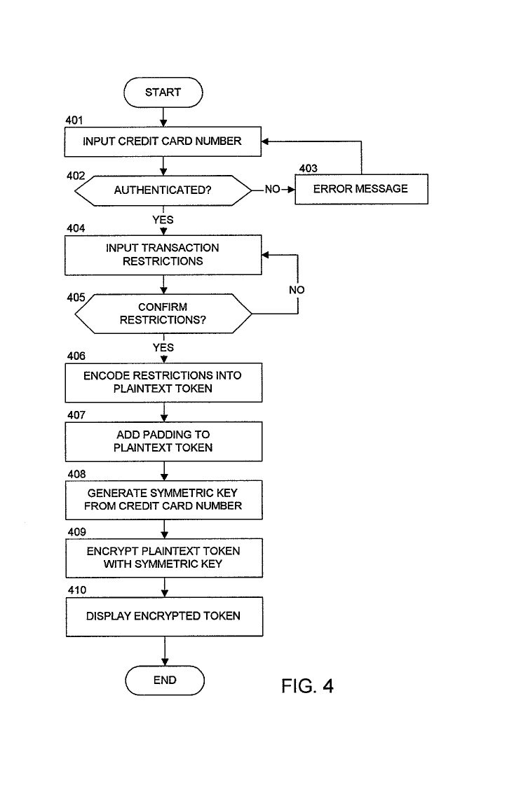

FIG. 4 is a flowchart of the processing performed by a token-generating application running on the card holder's computing device 110, in accordance with a preferred embodiment of the invention. At step 401, the card holder inputs her credit card number into the device for authentication. If the card holder is not authenticated, at step 402, then an error message is displayed at step 403. If the card holder is authenticated, the application presents the user interface for the selection of token restrictions. At step 404, the card holder inputs the token restrictions. Once the card holder has chosen all of the restrictions, the application displays the properties of the chosen token at step 405 and asks the card holder to confirm that this is what is desired. If not, the application permits the card holder to re-input the restrictions. If the card holder confirms the selection, the device commences the encryption process at step 406. At step 406, the restrictions are encoded into the plaintext token, as described above. At step 407, any necessary padding is computed and added to the plaintext token. At step 408, the symmetric key is generated from the account number. At step 409, the symmetric key is utilized to encrypt the plaintext token, resulting in the 16 digit encrypted token. At step 410, the encrypted token is displayed for the card holder, who can proceed to utilize it or provide it to another person for use in a credit card transaction. Or the card holder can presumably go back and modify the restrictions and create a different token or start over.

The intended user of a limited use token may be the card holder or another person, such as the user's child or a gift recipient. The user of the token is referred to herein as the “token user” or simply as the “user.” With reference again to FIG. 1, the token is utilized by the token user at step 104. The token is communicated to the merchant 130 along with identifying information, ID, such as the card holder's name and billing address. Where the token is being utilized in the context of an electronic transaction, e.g. over the Internet, it is advantageous to send the limited use token over an encrypted channel (using a security protocol such as SSL) to the merchant 130 so that eavesdroppers cannot overhear the token and try to use it before the merchant 130. Note that the use of a single-use token provides additional security, even if the merchant 130 is not known to be trustworthy. At this point, the merchant need not communicate any further with the token user. At step 105, the merchant 130 seeks verification from the card issuer 140 before fulfilling the user's order. The merchant 130 passes the token, T, and identifying information, ID, to the credit card issuer 140, who, at step 106, uses the identifying information to look up the card holder's account number. The card issuer can then use the account number (the derived key) to decrypt the token. The decrypted token is then checked for proper form and to ensure that the restrictions are met. At step 107, if the decryption is not proper, or if the restrictions are not met, the transaction is denied and a message to that effect returned to the merchant 130. If the decryption is proper and if the restrictions are met, then the merchant 130 is informed that the transaction is approved. Assuming the transaction is approved, the merchant continues with the transaction, e.g. by fulfilling the order at step 108 in FIG. 1.

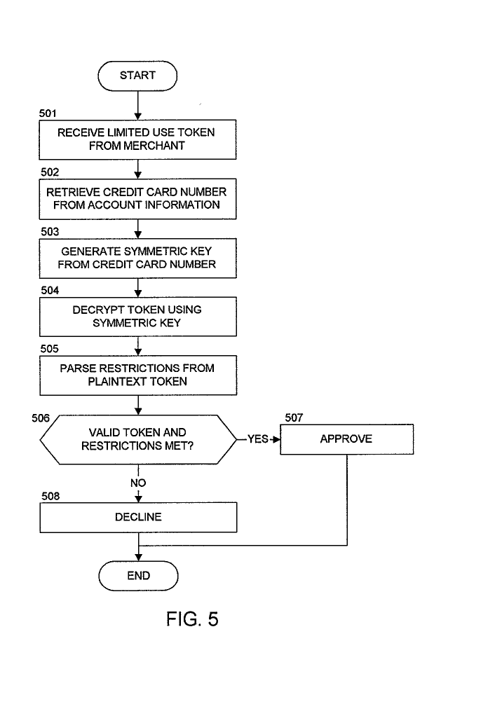

It is preferable for the card issuer to maintain an authorization server that automates the processes of steps 106 and 107. FIG. 5 is a flowchart of the processing performed by such an authorization server as operated by the card issuer. At step 501, the server receives a limited use token from the merchant along with account information identifying the relevant credit card account. At step 502, the account information is utilized to retrieve the account number from a database of card holders. At step 503, the symmetric cryptographic key is generated from the account number, using the same technique (e.g. the same cryptographic hash function) utilized by the token-generation application. Thus, the card issuer can obtain the same cryptographic key by applying the chosen function to the user's account number. Alternatively, the symmetric key can be pre-generated and stored with the other account information in the card holder record in the database. At step 504, the token is decrypted using the symmetric key, and, at step 505, the restrictions are retrieved and/or parsed from the plaintext token. At step 506, the token is checked for proper form and any restrictions encoded therein are verified. For example, if the token is a multiple-use token, the server looks for it in a database of multiple use tokens, adds it if it is not already there, and accounts for the current use (e.g. subtracting the monetary amount or decrementing the transaction count). When the remaining amount or transaction count reach 0, the token is removed from the database. If the restrictions are met, the card issuer at step 507 approves the transaction to the merchant, who then fulfills the user's order. If the restrictions are not met, then the card issuer at step 508 declines the transaction.

The present invention enables users to shop and transact at existing web merchant sites without exposing multiple-use credit card numbers, and without requiring changes to the web pages. The system is easy to use and does not place an unreasonable burden on the users. The protocol does not require users to learn dramatically new credit card transaction techniques or to adopt new ways of shopping. The system is interoperable with existing systems and can be layered on top of existing infrastructure. It is capable of deployment without requiring merchants to change their web sites. The tokens advantageously can be 16 digits long, enabling users to enter them into the existing credit card number field on web forms. Moreover, the protocol provides limited transparency—it should be clear to the card holders that they are not sending a multiple-use credit card number to the merchant.

The present invention, as an “off-line” protocol, also has advantages when compared to an on-line scenario where a user would obtain temporary credit card numbers from a central web site operated by the card issuer. When a user obtains a temporary credit card number from a central site, the connection to the credit card company (or perhaps directly to the issuing bank) should be over a secure connection using SSL. This is because the actual traditional credit card number needs to be provided, and it is important to secure the link. SSL places a performance burden on the server. Many simultaneous SSL connections could bring a server to its knees, and any solution involving a central SSL server does not scale well. In addition, with online schemes, the server must store all of the information about credit card numbers and restrictions in the database, along with the information that is already kept there. When a token is cleared, the server must search for the account. Moreover, a central site existing for the sole purpose of collecting credit card numbers from card holders surely represents a security risk. A spoofed site, for example, could collect legitimate credit card numbers from unsuspecting users. A simple attack against DNS and a certificate from any root CA is all an attacker needs to run a credit card collection site in the online model. The present off-line protocol does not share these problems with on-line protocols.

In accordance with another aspect of the invention, the offline protocol presented here advantageously can be used in the context of “calling cards” as well. Thus, the “card issuer” and the “card holder” can refer to the issuer and holder of a calling card account, as well as a credit card account. It is often a problem that malicious snoopers, sometimes referred to as “shoulder surfers,” watch people entering a calling card number into a public telephone. The security of a calling card account lies exclusively in the knowledge of the calling card number. If someone sees this number, that person can make virtually unlimited calls that are charged to the account holder. This can go undetected until the end of the billing cycle. In fact, many people now pay their telephone bills online, automatically, using a credit card number, and they may not notice unusual activity in their accounts until much later. The present invention can be applied to this situation. Rather than entering a calling card number directly into a public telephone, a calling card holder enters the calling card number into a computing device and then picks a set of restrictions, as described above. In this scenario, the restrictions can be the number of minutes, the telephone number called, etc. The device then outputs a new calling card number, which is in fact an encrypted token containing the selected restrictions. The cryptographic key utilized in encrypting the token is derived from the calling card number. When a user places a call with a token, the system can ask for some identifying information, such as a user's home phone number and zip code, in addition to the calling card number. This can be accomplished by having a different 800 access phone number for restricting tokens. When a user enters the token, the system uses the identifying information to look up the user's account number, derive a key, and then decrypt the token to check the restrictions.

The types of different restrictions that can be placed on calling cards introduces interesting possible applications. A card holder can provide the calling card token to a child that only permits telephone calls back to home. Other restrictions can involve the time of day, the area code and/or exchange called, the number of minutes, the number of calls permitted, etc. This allows the card holder great flexibility to manage risk and set parameters on temporary calling card numbers that are linked to an existing account.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. Embodiments within the scope of the present invention also include device readable media and computer readable media having executable program instructions or data fields stored thereon. Such computer readable media can be any available media which can be accessed by a general purpose or special purpose computing device. It is to be understood that the embodiments shown and described herein are only illustrative of the principles of the present invention and that various modifications may be implemented by those skilled in the art without departing from the scope and spirit of the invention.

1. A method for facilitating transactions, comprising the steps of:
receiving from a merchant, desiring to receive authorization for a transaction, a token and information identifying an account with a card issuer;
decrypting the token using a symmetric cryptographic key converted from an account number associated with the account with the card issuer; and
verifying information retrieved from the token and approving the transaction if the transaction satisfies any restrictions retrieved from the token.

2. The invention of claim 1 wherein the token has a length that is identical to the account number.

3. The invention of claim 2 wherein the card is a credit card and wherein the account number is a credit card number.

4. The invention of claim 2 wherein the card is a calling card and wherein the account number is a calling card number.

5. The invention of claim 3 or 4 wherein the symmetric cryptographic key is converted from an account number using a cryptographic hash function.

6. The invention of claim 3 wherein the restrictions retrieved from the token are selected from the group consisting of restrictions on a monetary limit, restrictions on number of uses, monetary restrictions, restrictions on category of product, restrictions on recipients, and restrictions on validity period of the token.

7. The invention of claim 4 wherein the restrictions retrieved from the token are selected from the group consisting of restrictions on calling number, restrictions on time of call, restrictions on duration of call, and restrictions on number of calls.

8. A method for facilitating transactions, comprising the steps of:
receiving an account number and a set of transaction restrictions from a user having an account with a card issuer;
converting the account number into a symmetric cryptographic key; and
encrypting information encoding the restrictions using the symmetric cryptographic key to obtain a token which may be utilized in a transaction and verified by a card issuer using the account number.

9. The invention of claim 8 wherein the token has a length that is identical to the account number.

10. The invention of claim 9 wherein the card is a credit card and wherein the account number is a credit card number.

11. The invention of claim 9 wherein the card is a calling card and wherein the account number is a calling card number.

12. The invention of claim 10 or 11 wherein the symmetric cryptographic key is converted from an account number using a cryptographic hash function.

13. The invention of claim 10 wherein the restrictions encoded in information in the token are selected from the group consisting of restrictions on a monetary limit, restrictions on number of uses, monetary restrictions, restrictions on category of product, restrictions on recipients, and restrictions on validity period of the token.

14. The invention of claim 11 wherein the restrictions encoded in information in the token are selected from the group consisting of restrictions on calling number, restrictions on time of call, restrictions on duration of call, and restrictions on number of calls.

15. A processor readable medium containing executable program instructions for performing a method on a device, comprising the steps of:
receiving an account number and a set of transaction restrictions from a user having an account with a card issuer;
converting the account number into a symmetric cryptographic key; and
encrypting information encoding the restrictions using the symmetric cryptographic key to obtain a token which may be utilized in a transaction and verified by a card issuer using the account number.

16. The invention of claim 15 wherein the token has a length that is identical to the account number.

17. The invention of claim 16 wherein the card is a credit card and wherein the account number is a credit card number.

18. The invention of claim 16 wherein the card is a calling card and wherein the account number is a calling card number.

19. The invention of claim 17 or 18 wherein the symmetric cryptographic key is converted from an account number using a cryptographic hash function.

20. The invention of claim 17 wherein the restrictions encoded in information in the token are selected from the group consisting of restrictions on a monetary limit, restrictions on number of uses, monetary restrictions, restrictions on category of product, restrictions on recipients, and restrictions on validity period of the token.

21. The invention of claim 18 wherein the restrictions encoded in information in the token are selected from the group consisting of restrictions on calling number, restrictions on time of call, restrictions on duration of call, and restrictions on number of calls.
